(19) United States
(12) Patent Application Publication
(10) Pub. No.: US 2009/0283075 A1
(43) Pub. Date: Nov. 19, 2009

(54) INTERNAL COMBUSTION ENGINE APPARATUS, VEHICLE INCLUDING INTERNAL COMBUSTION ENGINE APPARATUS, AND CONTROL METHOD OF INTERNAL COMBUSTION ENGINE APPARATUS

(75) Inventors: Makoto Yamazaki, Gotenba-shi (JP); Shunsuke Fushiki, Susono-shi (JP); Keita Fukui, Susono-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Aichi-Ken (JP)

(21) Appl. No.: 12/466,622

(22) Filed: May 15, 2009

(30) Foreign Application Priority Data
May 19, 2008 (JP) JP2008-130379

(51) Int. Cl. F02M 33/02; F02D 41/00

(52) U.S. Cl. 123/521; 701/103

(57) ABSTRACT

In performing purge control, an engine ECU 24 of a hybrid vehicle derives a purge air amount ga and a purge fuel amount tau on the basis of intake pipe pressure PM from an intake pipe pressure sensor 112 when the intake pipe pressure sensor 112 is functioning normally, and derives the purge air amount ga and the purge fuel amount tau on the basis of a load factor L derived from an intake air flow G obtained from an air flow meter 108 when the intake pipe pressure sensor 112 is not functioning normally, though the purge air amount ga and the purge fuel amount tau tend to have slightly larger errors than in the case of using the intake pipe pressure PM from the intake pipe pressure sensor 112 functioning normally. Thus, even when the intake pipe pressure sensor 112 is not functioning normally, a deviation of an air/fuel ratio caused by the purge control can be appropriately eliminated.

### BACKGROUND OF THE INVENTION

1. Field of the Invention

The present invention relates to an internal combustion engine apparatus, a vehicle including the internal combustion engine apparatus, and a control method of the internal combustion engine apparatus.

2. Description of the Prior Art

A conventionally proposed internal combustion engine apparatus can perform so-called purge control (also referred to as canister purge) for causing a canister to absorb vaporized fuel generated in a fuel tank, and introducing the vaporized fuel absorbed by the canister into an intake pipe together with outside air using negative pressure in the intake pipe. When such purge control is performed, a deviation of an air/fuel ratio occurs in air/fuel ratio control, and thus correction for eliminating the deviation is needed. In the air/fuel ratio control, a fuel injection amount is generally set on the basis of an intake air flow of air (new air) newly taken into an intake pipe and a target air/fuel ratio. When purge control is performed, however, a purge gas containing vaporized fuel and outside air is also introduced into the intake pipe besides the new air, and thus a fuel injection amount needs to be corrected in view of amounts of air and fuel contained in the purge gas. For example, in Japanese Patent Laid-Open No. 2002-349363, a surge tank in an internal combustion engine includes an intake pipe pressure sensor and an intake oxygen sensor, amounts of air and fuel contained in a purge gas are calculated from an output value from the intake oxygen sensor and intake pipe pressure from the intake pipe pressure sensor, and a fuel injection amount is corrected on the basis of the amounts so as to eliminate a deviation of an air/fuel ratio.

### SUMMARY OF THE INVENTION

However, for the above described internal combustion engine apparatus, when the intake pipe pressure sensor is disconnected or short-circuited or a pressure introducing port is clogged with foreign matter and an output value is fixed at a constant value to cause abnormalities, or when water droplets near the pressure introducing port of the intake pipe pressure sensor freeze at a low temperature to cause abnormalities, reliability of the intake pipe pressure detected by the intake pipe pressure sensor is reduced and thus a deviation of an air/fuel ratio caused by purge control cannot be sufficiently eliminated.

The present invention has a main object to provide an internal combustion engine apparatus, a vehicle including the internal combustion engine apparatus, and a control method of the internal combustion engine apparatus that can perform more appropriate air/fuel ratio control of an internal combustion engine in performing purge control.

To achieve at least the above main object, the present invention provides an internal combustion engine apparatus, a vehicle including the internal combustion engine apparatus, and a control method of the internal combustion engine apparatus as described below.

According to one aspect, the present invention is directed to an internal combustion engine apparatus of the present invention includes: an internal combustion engine; an air amount adjustment unit that is mounted to an intake pipe of the internal combustion engine and adjusts an amount of air taken into the intake pipe; an intake pipe pressure detection unit that is mounted downstream of the air amount adjustment unit and detects intake pipe pressure; an intake air flow detection unit that is mounted upstream of the air amount adjustment unit and detects the amount of air taken into the intake pipe; a vaporized fuel capturing unit that captures vaporized fuel in a fuel tank that stores fuel to be supplied to the internal combustion engine; a purge passage connecting the vaporized fuel capturing unit and the intake pipe; and a purge control performing unit that, in performing purge control for introducing vaporized fuel captured by the vaporized fuel capturing unit through the purge passage into the intake pipe using negative pressure in the intake pipe, estimates amounts of purge air and purge fuel contained in a purge gas flowing into the intake pipe during the purge control on the basis of the intake pipe pressure detected by the intake pipe pressure detection unit when the intake pipe pressure detection unit is functioning normally, and estimates the amounts of purge air and purge fuel on the basis of the intake air flow detected by the intake air flow detection unit when the intake pipe pressure detection unit is not functioning normally.

In the internal combustion engine apparatus of the present invention, the amounts of purge air and purge fuel contained in the purge gas flowing into the intake pipe during performing the purge control are estimated on the basis of the intake pipe pressure detected by the intake pipe pressure detection unit when the intake pipe pressure detection unit is functioning normally, and the amounts of purge air and purge fuel are estimated on the basis of the intake air flow detected by the intake air flow detection unit when the intake pipe pressure detection unit is not functioning normally, in performing the purge control for introducing the vaporized fuel captured by the vaporized fuel capturing unit through the purge passage into the intake pipe using the negative pressure in the intake pipe. Thus, even when reliability of the intake pipe pressure detected by the intake pipe pressure detection unit is reduced, the amounts of purge air and purge fuel are estimated on the basis of the intake air flow detected by the intake air flow detection unit, thereby allowing a deviation of an air/fuel ratio caused by the purge control to be appropriately eliminated.

The amounts of purge air and purge fuel estimated on the basis of the intake air flow detected by the intake air flow detection unit tend to have slightly larger errors than the amounts of purge air and purge fuel estimated on the basis of the intake pipe pressure detected by the intake pipe pressure detection unit functioning normally, but are sufficiently usable when the intake pipe pressure detection unit is not functioning normally. When the intake pipe pressure detection unit is likely to be not functioning normally, the intake pipe pressure detection unit may be determined to be not functioning normally.

In the internal combustion engine apparatus of the present invention, the purge control performing unit may determine that the intake pipe pressure detection unit is not functioning normally when the intake pipe pressure detection unit is disconnected or short-circuited. Thus, even when the intake pipe pressure detection unit is disconnected or short-circuited, a deviation of an air/fuel ratio caused by the purge control can be appropriately eliminated.

In the internal combustion engine apparatus of the present invention, the purge control performing unit may determine that the intake pipe pressure detection unit is not functioning normally when the intake pipe pressure detected by the intake pipe pressure detection unit during operation of the internal combustion engine exceeds reference atmospheric pressure. Since negative pressure is generated in the intake pipe during the operation of the internal combustion engine, the intake pipe pressure is to be actually lower than the reference atmospheric pressure. Thus, when the detected intake pipe pressure exceeds the reference atmospheric pressure, the intake pipe pressure detection unit is determined to be not functioning normally.

In the internal combustion engine apparatus of the present invention, the purge control performing unit may determine that the intake pipe pressure detection unit is not functioning normally when the intake pipe pressure detected by the intake pipe pressure detection unit is fixed at a constant value irrespective of an operation state of the internal combustion engine. Negative pressure is generated in the intake pipe during the operation of the internal combustion engine and is not generated in the intake pipe during stop of the operation, and thus the intake pipe pressure detected by the intake pipe pressure detection unit is to be changed according to the operation state of the internal combustion engine. Thus, when the detected intake pipe pressure is fixed at a constant value irrespective of the operation state of the internal combustion engine, the intake pipe pressure detection unit is determined to be not functioning normally.

In the internal combustion engine apparatus of the present invention, the purge control performing unit may determine that the intake pipe pressure detection unit is not functioning normally when an ambient temperature of the intake pipe pressure detection unit is within a predetermined low temperature range. The intake pipe pressure detection unit generally includes a pressure introducing port, and when water droplets adhere to the pressure introducing port, the water droplets freeze at a low temperature to prevent detection of the intake pipe pressure or reduce detection accuracy. Thus, when the ambient temperature of the intake pipe pressure detection unit is within the predetermined low temperature range (for example, a water freezing temperature range), the intake pipe pressure detection unit is not likely to be functioning normally and thus determined to be not functioning normally.

A vehicle of the present invention includes the internal combustion engine apparatus according to any of the above described aspects of the present invention, and drives using power from the internal combustion engine. The vehicle of the present invention includes the internal combustion engine apparatus according to any of the above described aspects of the present invention, and thus can provide an advantage of the internal combustion engine apparatus of the present invention, for example, an advantage that the amounts of purge air and purge fuel are estimated on the basis of the intake air flow detected by the intake air flow detection unit even when reliability of the intake pipe pressure detected by the intake pipe pressure detection unit is reduced, thereby allowing a deviation of an air/fuel ratio caused by the purge control to be appropriately eliminated.

According to another aspect, the present invention is also directed to a control method that is executed by a computer software and is applied to an internal combustion engine apparatus including: an internal combustion engine; an air amount adjustment unit that is mounted to an intake pipe of the internal combustion engine and adjusts an amount of air taken into the intake pipe; an intake pipe pressure detection unit that is mounted downstream of the air amount adjustment unit and detects intake pipe pressure; an intake air flow detection unit that is mounted upstream of the air amount adjustment unit and detects the amount of air taken into the intake pipe; a vaporized fuel capturing unit that captures vaporized fuel in a fuel tank that stores fuel to be supplied to the internal combustion engine; and a purge passage connecting the vaporized fuel capturing unit and the intake pipe. The control method including: in performing purge control for introducing vaporized fuel captured by the vaporized fuel capturing unit through the purge passage into the intake pipe using negative pressure in the intake pipe, estimating amounts of purge air and purge fuel contained in a purge gas flowing into the intake pipe during the purge control on the basis of the intake pipe pressure detected by the intake pipe pressure detection unit when the intake pipe pressure detection unit is functioning normally, and estimating the amounts of purge air and purge fuel on the basis of the intake air flow detected by the intake air flow detection unit when the intake pipe pressure detection unit is not functioning normally.

In the control method of the internal combustion engine apparatus of the present invention, the amounts of purge air and purge fuel contained in the purge gas flowing into the intake pipe during performing the purge control are estimated on the basis of the intake pipe pressure detected by the intake pipe pressure detection unit when the intake pipe pressure detection unit is functioning normally, and the amounts of purge air and purge fuel are estimated on the basis of the intake air flow detected by the intake air flow detection unit when the intake pipe pressure detection unit is not functioning normally, in performing the purge control for introducing the vaporized fuel captured by the vaporized fuel capturing unit through the purge passage into the intake pipe using the negative pressure in the intake pipe. Thus, even when reliability of the intake pipe pressure detected by the intake pipe pressure detection unit is reduced, the amounts of purge air and purge fuel are estimated on the basis of the intake air flow detected by the intake air flow detection unit, thereby allowing a deviation of an air/fuel ratio caused by the purge control to be appropriately eliminated. The control method of the present invention may further have additional features described above in connection with the internal combustion engine apparatus of the present invention.

### BRIEF DESCRIPTION OF THE DRAWINGS

FIG. 1 is a schematic diagram of a configuration of a hybrid vehicle 20 including an internal combustion engine apparatus according to an embodiment of the present invention;

FIG. 2 is a schematic diagram of a configuration of an engine 22;

FIG. 3 is a flowchart showing a fuel injection amount calculation routine executed by an engine ECU 24;

FIG. 4 shows an example of a map of relationship between an intake pipe pressure PM and an output value from an intake oxygen sensor; and

FIG. 5 shows an example of a map of relationship between load factor L and an intake pipe negative pressure NP.

### DESCRIPTION OF THE PREFERRED EMBODIMENTS

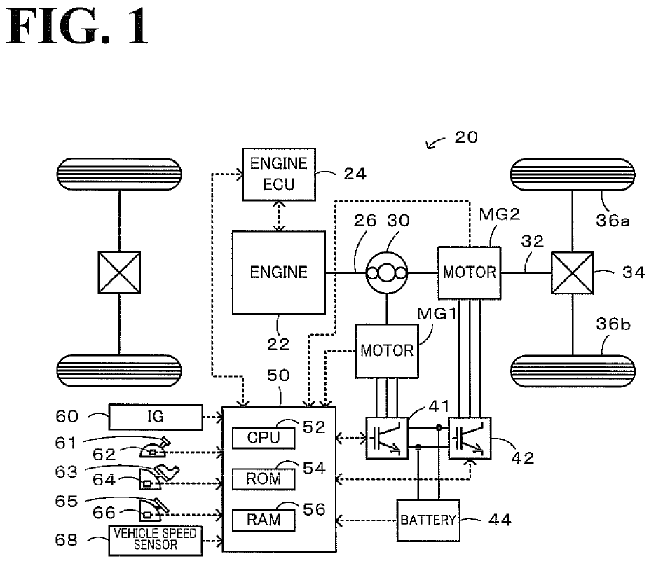

FIG. 1 is a schematic diagram of a configuration of a hybrid vehicle 20 including an internal combustion engine apparatus according to an embodiment of the present invention. As shown in FIG. 1, the hybrid vehicle 20 of the embodiment includes an engine 22 configured as an internal combustion engine that outputs power using hydrocarbon fuel such as gasoline, a planetary gear mechanism 30 including a carrier connected to a crankshaft 26 as an output shaft of the engine 22 via a damper, a motor MG1 as a synchronous motor generator including a rotor connected to a sun gear of the planetary gear mechanism 30, a motor MG2 as a synchronous motor generator connected to a ring gear of the planetary gear mechanism 30 and including a rotor connected to a drive shaft 32 connected to drive wheels 36a and 36b via a differential gear 34, a battery 44 connected to the motors MG1 and MG2 via inverters 41 and 42, and a hybrid electronic control unit (HVECU) 50 that controls the entire vehicle.

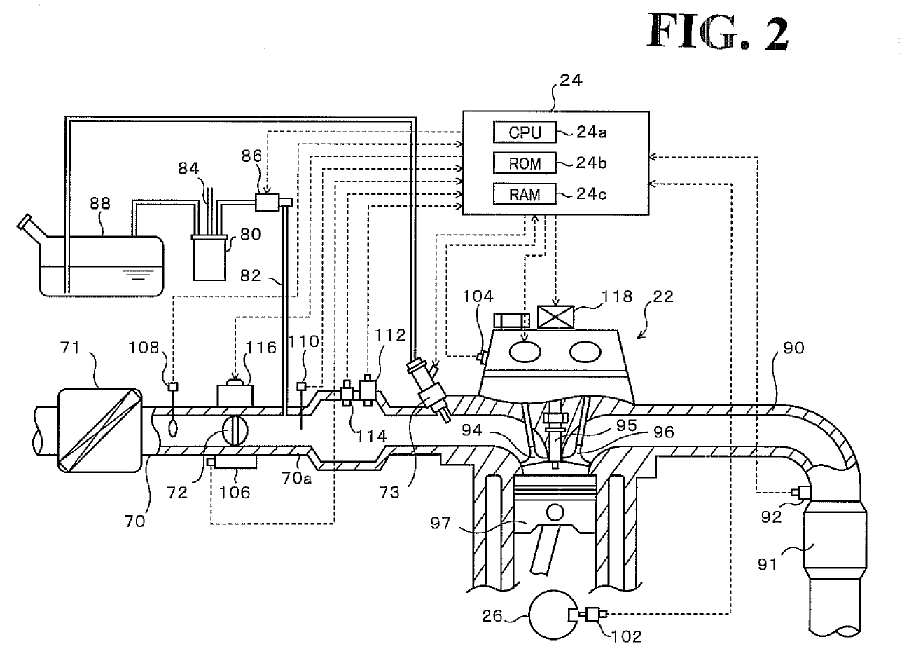

As shown in FIG. 2, the engine 22 is connected to an intake passage 70 and an exhaust passage 90. To the intake passage 70, an air cleaner 71 for cleaning air, a throttle valve 72 for adjusting a flow rate of air having passed through the air cleaner 71, and a fuel injection valve 73 that injects fuel to an intake port near an intake valve of the engine 22 are mounted. In the embodiment, a downstream side of the throttle valve 72 in the intake passage 70 is referred to as an intake pipe 70a. The intake pipe 70a is connected to a canister 80 via a purge passage 82. The canister 80 absorbs vaporized fuel generated in a fuel tank 88 that supplies fuel to the fuel injection valve 73 with an absorber such as activated carbon. When negative pressure is generated in the intake pipe 70a during operation of the engine 22, outside air flows inside through an atmosphere passing hole 84, a purge gas containing fuel desorbed from the absorber and the outside air is discharged (purged) through the purge passage 82 to the intake pipe 70a. The purge passage 82 includes a purge VSV (vacuum switching valve) 86 as a purge control valve, and on/off of the purge VSV 86 can be controlled to adjust a flow rate of the purge gas discharged to the intake pipe 70a. On the other hand, to the exhaust passage 90, a purification device 91 including a three way catalyst for removing harmful components such as carbon monoxide (CO), hydrocarbon (HC), and nitrogen oxide (NOx), and an air/fuel ratio sensor 92 for detecting an air/fuel ratio (A/F) of an exhaust gas on an upstream side of the purification device 91 are mounted. The engine 22 takes an air/fuel mixture of air having passed through the air cleaner 71, a purge gas having passed through the purge passage 82, and fuel injected from the fuel injection valve 73 into a combustion chamber via an intake valve 94, the air/fuel mixture is subjected to explosive combustion with electric spark by an ignition plug 95, reciprocation of a piston 97 pushed down by energy of the explosive combustion is converted into a rotary motion of the crankshaft 26. The exhaust gas from the engine 22 is discharged to the exhaust passage 90 via an exhaust valve 96, purified by passing through the purification device 91, and then discharged to the outside.

The engine 22 is under control of an engine electronic control unit 24 (hereafter referred to as engine ECU 24). The engine ECU 24 is constructed as a microprocessor including a CPU 24a, a ROM 24b that stores processing programs, a RAM 24c that temporarily stores data, input and output ports (not shown), and a communication port (not shown). The engine ECU 24 receives, via its input port, signals from various sensors that measure and detect the conditions of the engine 22. The signals input into the engine ECU 24 include a rotation speed of the engine from a crank position sensor 102 that detects rotational position of the crankshaft 26, a cam position from a cam position sensor 104 detected as the rotational position of a camshaft driven to open and close the intake valve 94 and an exhaust valve 96 for gas intake and exhaust into and from the combustion chamber, a throttle valve position from a throttle valve position sensor 106 detected as the opening or position of the throttle valve 72, an intake air flow from a hot-wire air flow meter 108 attached to the intake pipe 70a, an intake air temperature from a temperature sensor 110 attached to the intake pipe 70a, an intake pipe pressure from a silicon diaphragm intake pipe pressure sensor 112 attached to the intake pipe 70a, an intake oxygen signal from an intake oxygen sensor 114, and an air/fuel ratio from an air/fuel ratio sensor 92. The engine ECU 24 outputs, via its output port, diverse control signals and driving signals to drive and control the engine 22, for example, driving signals to the fuel injection valve 73, driving signals to a throttle valve motor 116 for regulating the position of the throttle valve 72, control signals to an ignition coil 118 integrated with an igniter, and driving signals to a purge VSV 86. The engine ECU 24 communicates with the HVECU 50. The engine ECU 24 receives control signals from the HVECU 50 to drive and control the engine 22, while outputting data regarding the driving conditions of the engine 22 to the HVECU 50 according to the requirements.

The HVECU 50 is constructed as a microprocessor including a CPU 52, a ROM 54 that stores processing programs, a RAM 56 that temporarily stores data, and a non-illustrated input-output port, and a non-illustrated communication port. The HVECU 50 receives various inputs via the input port: rotational positions of rotors of the motors MG1 and MG2 from a non-illustrated rotational position detection sensors, a phase current from non-illustrated current sensors attached to electric power lines connecting the inverters 41 and 42 to the motors MG1 and MG2, a charge-discharge current from a non-illustrated current sensor attached in the vicinity of an output terminal of the battery 44, a battery temperature from a non-illustrated temperature sensor attached to the battery 44, an ignition signal from an ignition switch 60, a gearshift position SP from a gearshift position sensor 62 that detects the current position of a gearshift lever 61, an accelerator opening Acc from an accelerator pedal position sensor 64 that measures a step-on amount of an accelerator pedal 63, a brake pedal position BP from a brake pedal position sensor 66 that measures a step-on amount of a brake pedal 65, and a vehicle speed V from a vehicle speed sensor 68. The HVECU 50 outputs various signals such as a switching control signal output to the inverters 41 and 42. The HVECU 50 communicates with the engine ECU 24 via the communication port to transmit diverse control signals and data to and from the engine ECU 24.

The hybrid vehicle 20 of the embodiment thus constructed calculates a torque demand to be output to the driveshaft 32 functioning as the drive shaft, based on observed values of a vehicle speed V and an accelerator opening Acc, which corresponds to a driver's step-on amount of an accelerator pedal 63. The engine 22 and the motors MG1 and MG2 are subjected to operation control to output a required level of power corresponding to the calculated torque demand to the driveshaft 32. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the driveshaft 32. The charge-discharge drive mode controls the operations of the engine 22 to output a quantity of power equivalent to the sum of the required level of power and a quantity of electric power consumed by charging the battery 44 or supplied by discharging the battery 44, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the drive shaft 32, simultaneously with charge or discharge of the battery 44. The motor drive mode stops the operations of the engine 22 and drives and controls the motor MG2 to output a quantity of power equivalent to the required level of power to the driveshaft 32. The HVECU 50 sets a target rotation speed and a target torque of engine 22 and torque commands of motors MG1 and MG2 so that power demand corresponding to a torque demand is output to the driveshaft 32 while switching these modes, sends the set target rotation speed and target torque of the engine 22 to the engine ECU 24, and controls inverters 41 and 42 to cause the motors MG1 and MG2 to be driven with the set torque commands.

In the hybrid vehicle 20 of the embodiment, the engine ECU 24 performs control such as throttle opening control for adjusting opening of the throttle valve 72 so that the engine 22 is efficiently operated at an operation point indicated by the target rotation speed and the target torque of the engine 22, fuel injection control for adjusting a fuel injection amount from the fuel injection valve 73, and ignition control for controlling ignition timing by the ignition plug 95.

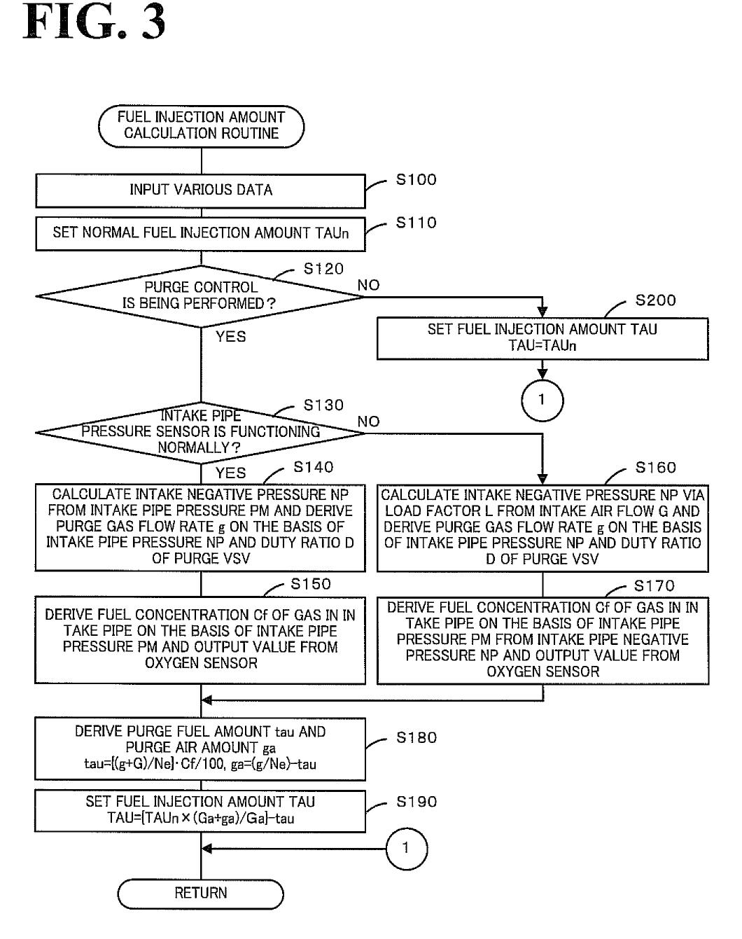

Next, an operation will be described when an injection amount from the fuel injection valve 73 is calculated in the engine 22 mounted in the hybrid vehicle 20 of the embodiment thus configured. FIG. 3 is a flowchart of an example of a fuel injection amount calculation routine executed by the engine ECU 24. The routine is repeatedly executed at predetermined time intervals (for example, every several msec) during the operation of the engine 22.

When the fuel injection amount calculation routine is executed, the CPU 24a of the engine ECU 24 first executes a processing of inputting data such as an intake air flow G from the air flow meter 108, an engine rotation speed Ne from the crank position sensor 102, an intake pipe pressure PM from the intake pipe pressure sensor 112, an air/fuel ratio Vaf from the air/fuel ratio sensor 92, and an output value from the intake oxygen sensor 114 (Step S100). Various data are thus inputted, and then a normal fuel injection amount TAUn is calculated (Step S110). The intake air flow G from the air flow meter 108 is air mass per unit time. Thus, the intake air flow G is divided by the engine rotation speed Ne to calculate an intake air flow Ga (=G/Ne) of new air taken into the intake pipe 70a during one rotation of the engine, a value obtained by dividing the intake air flow Ga by a target air/fuel ratio AF* such as a theoretical air/fuel ratio is multiplied by a constant K determined by a size of the fuel injection valve 73 or the number of cylinders of the engine 22 to calculate a basic injection amount Tp, and the basic injection amount Tp is subjected to air/fuel ratio feedback correction to calculate the normal fuel injection amount TAUn as a fuel amount to be injected from the fuel injection valve 73. The air/fuel ratio feedback correction is performed by calculating a feedback correction coefficient k for feedback correction of the fuel injection amount so that the air/fuel ratio Vaf from the air/fuel ratio sensor 92 reaches a target air/fuel ratio, and multiplying the basic injection amount Tp by the feedback correction coefficient k. Calculation formulas of the basic injection amount Tp and the normal fuel injection amount TAUn after the air/fuel ratio feedback correction are expressed in Formulas (1) and (2).

Tp=K·(G/Ne)/AF* (1)

TAUn=k·Tp (2)

Then, the CPU 24a of the engine ECU 24 determines whether purge control is being performed (Step S120). Since the vaporized fuel generated in the fuel tank 88 is absorbed by the canister 80 during the stop of the engine, the purge control is performed during the operation of the engine 22 to discharge (purge) the vaporized fuel absorbed by the canister 80 so that further vaporized fuel can be absorbed when the engine 22 is next stopped. The purge control is to introduce outside air through the atmosphere passing hole 84 and discharge the vaporized fuel absorbed by the canister 80 as a purge gas (mixture of the vaporized fuel and the outside air) through the purge passage 82 to the intake pipe 70a using negative pressure in the intake pipe 70a generated during the operation of the engine 22. The purge control is performed during the operation of the engine 22 in principle, but even during the operation of the engine 22, the purge control is not performed until warming-up is finished or during fuel cut.

When the purge control is not being performed in Step S120, the normal fuel injection amount TAUn calculated in Step S110 is set to a fuel injection amount TAU to be injected from the fuel injection valve 73 (Step S200). On the other hand, when the purge control is being performed in Step S120, it is determined whether the intake pipe pressure sensor 112 is functioning normally (Step S130). The intake pipe pressure sensor 112 is herein determined to be not functioning normally when at least one of the following four conditions is satisfied: (a) the intake pipe pressure sensor 112 is disconnected or short-circuited; (b) an intake temperature from the temperature sensor 110 mounted to the intake pipe 70a is a water freezing temperature (0° C.) or less; (c) the intake pipe pressure PM from the intake pipe pressure sensor 112 during the operation of the engine 22 exceeds the reference atmospheric pressure Pref; and (d) the intake pipe pressure PM from the intake pipe pressure sensor 112 is constant irrespective of the operation state of the engine 22.

The condition (a) is set because when the intake pipe pressure sensor 112 is disconnected or short-circuited, the intake pipe pressure PM from the intake pipe pressure sensor 112 does not reflect actual intake pipe pressure. The condition (b) is set because when the intake temperature is the water freezing temperature or less, water accumulated on an unshown pressure introducing port of the intake pipe pressure sensor 112 may freeze to prevent a gas in the intake pipe 70a from flowing into the pressure introducing port, and reduce accuracy of the detected intake pipe pressure PM. The condition (c) is set because the piston 97 is lowered with the intake valve 94 being opened in an intake stroke to generate negative pressure in the intake pipe 70a during the operation of the engine 22, and thus the intake pipe pressure PM from the intake pipe pressure sensor 112 normally cannot exceed the reference atmospheric pressure Pref. The reference atmospheric pressure Pref may be intake pipe pressure PM (=atmospheric pressure) from the intake pipe pressure sensor 112 during the stop of the engine 22, or a pressure value from a separately provided atmospheric pressure sensor that can measure pressure outside the intake pipe 70a. It may be determined whether the intake pipe pressure PM exceeds a threshold obtained by adding predetermined pressure to the reference atmospheric pressure Pref, rather than the reference atmospheric pressure Pref. The threshold may be a value obtained, for example, by experiment, which the intake pipe pressure cannot reach during the operation of the engine 22. The condition (d) is set because the actual intake pipe pressure is changed according to whether the engine 22 is being stopped or operated, and thus the intake pipe pressure PM from the intake pipe pressure sensor 112 normally cannot be constant irrespective of the operation state of the engine 22.

When the intake pipe pressure sensor 112 is functioning normally in Step S130, intake pipe negative pressure NP obtained by subtracting the reference atmospheric pressure Pref from the intake pipe pressure PM obtained from the intake pipe pressure sensor 112 is calculated, and a purge gas flow rate (mass flow rate) g per unit time is calculated on the basis of the intake pipe negative pressure NP and a duty ratio D of the purge VSV 86 (Step S140). Also, a fuel concentration Cf (% by weight) of a gas existing in the intake pipe 70a (hereinafter referred to as a gas in the intake pipe) is calculated on the basis of the intake pipe pressure PM from the intake pipe pressure sensor 112 and the output value from the intake oxygen sensor 114 (Step S150).

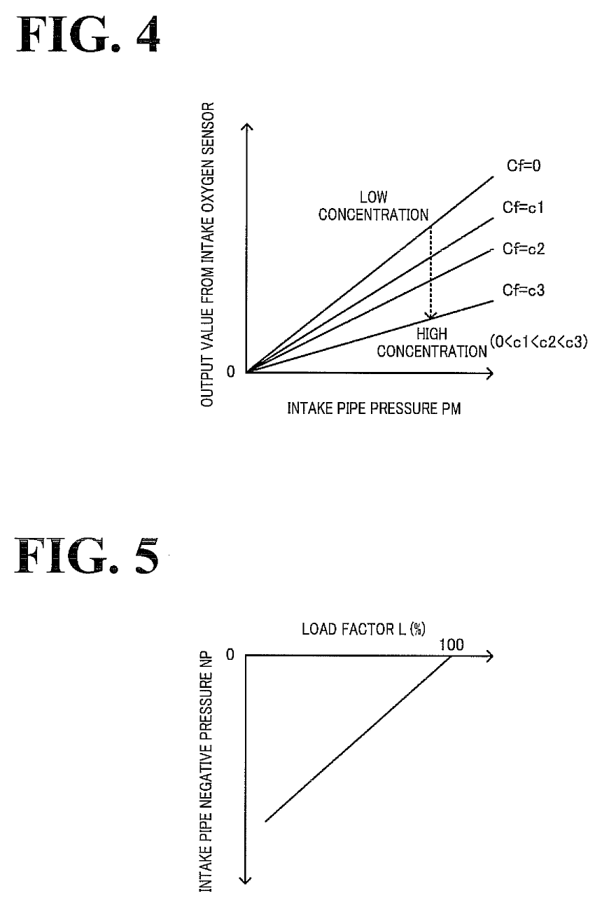

In the embodiment, a relationship between the intake pipe negative pressure NP, the duty ratio D of the purge VSV 86, and the purge gas flow rate g is previously stored as a map in the ROM 24b. Generally, a pressure difference between the intake pipe 70a and the canister 80 with the purge VSV 86 therebetween increases with increasing absolute value of the intake pipe negative pressure NP, and thus the purge gas flow rate g tends to increase. Opening of the purge VSV 86 increases with increasing duty ratio D of the purge VSV 86, and thus the purge gas flow rate g tends to increase. Thus, the relationship between the intake pipe negative pressure NP, the duty ratio D of the purge VSV 86, and the purge gas flow rate g is previously calculated by experiment and stored as a map in the ROM 24b, and in Step S140, the intake pipe negative pressure NP and the duty ratio D of the purge VSV 86 are checked against the map to read out the purge gas flow rate g. As shown in FIG. 4, the relationship between the intake pipe pressure PM from the intake pipe pressure sensor 112 and the output value from the intake oxygen sensor 114 is expressed as a straight line with a steepest inclination when the fuel concentration Cf of the gas in the intake pipe is zero, and expressed as a straight line with more gentle inclination with increasing fuel concentration Cf of the gas in the intake pipe. This relationship is also stored in the ROM 24b. The intake oxygen sensor 114 outputs a value according to the number of oxygen molecules on a surface of a sensor element. The number of oxygen molecules on the surface of the sensor element increases or decreases according to the intake pipe pressure PM. Thus, an output property of the intake oxygen sensor 114 depends on the intake pipe pressure PM. When the gas in the intake pipe contains fuel such as gasoline, the fuel reacts with oxygen on the surface of the sensor element, and thus the number of oxygen molecules on the surface of the sensor element decreases. Therefore, as shown in FIG. 4, the output value from the intake oxygen sensor 114 tends to decrease with increasing fuel concentration Cf of the gas in the intake pipe. Thus, the fuel concentration Cf of the gas in the intake pipe can be calculated from FIG. 4 on the basis of the intake pipe pressure PM from the intake pipe pressure sensor 112 and the output value from the intake oxygen sensor 114.

On the other hand, when the intake pipe pressure sensor 112 is not functioning normally in Step S130, a load factor L of the engine 22 is calculated on the basis of the intake air flow G from the air flow meter 108 and the engine rotation speed Ne rather than the intake pipe pressure PM from the intake pipe pressure sensor 112, the intake pipe negative pressure NP is estimated from the load factor L, and the purge gas flow rate g is calculated on the basis of the estimated intake pipe negative pressure NP and the duty ratio D of the purge VSV 86 (Step S160). Also, the sum of the estimated intake pipe negative pressure NP (<0) and the reference atmospheric pressure Pref is determined as intake pipe pressure PM, and the fuel concentration Cf of the gas in the intake pipe is calculated on the basis of the intake pipe pressure PM and the output value from the intake oxygen sensor 114 (Step S170).

In the embodiment, the load factor L is a ratio of an intake air flow (mass flow rate) Ga per one rotation of the engine to a maximum intake air flow (mass flow rate) Gamax per one rotation of the engine when the throttle valve 72 is fully opened, expressed in percent as in Formula (3) below. The intake air flow Ga is a value obtained by dividing the intake air flow G per unit time obtained from the air flow meter 108 by the engine rotation speed Ne. The load factor L has a correlation with the intake pipe negative pressure NP as shown in FIG. 5. For example, when the throttle valve 72 is fully opened, the load factor L is 100%, and the intake pipe negative pressure NP at the time is zero because the inside of the intake pipe 70a is opened to atmospheric pressure. As such, the load factor L is calculated by Formula (3) from the intake air flow G obtained from the air flow meter 108 and the engine rotation speed Ne obtained from the crank position sensor 102, and intake pipe negative pressure NP corresponding to the load factor L can be read in FIG. 5 to estimate the intake pipe negative pressure NP. Further, the sum of the intake pipe negative pressure NP (<0) and the reference atmospheric pressure Pref can be calculated and determined as the intake pipe pressure PM. From the intake pipe negative pressure NP and the intake pipe pressure PM thus estimated, the purge gas flow rate g and the fuel concentration Cf of the gas in the intake pipe can be calculated as in Steps S140 and S150. A map used at the time may be the same as or different from the map used in Steps S140 and S150.

L=(Ga/Gamax)·100 (3)

The purge gas flow rate g and the fuel concentration Cf calculated from the intake pipe negative pressure NP estimated on the basis of the intake air flow G obtained from the air flow meter 108 tend to have slightly larger errors than the purge gas flow rate g and the fuel concentration Cf calculated from the intake pipe pressure PM obtained from the intake pipe pressure sensor 112 functioning normally, but are sufficiently usable when the intake pipe pressure sensor 112 is not functioning normally.

After the purge gas flow rate g and the fuel concentration Cf per unit time are calculated in Steps S140 and S150 or Steps S160 and S170, a purge fuel amount tau and a purge air amount ga purged to the intake pipe 70a per one rotation of the engine are calculated (Step S180). The purge gas contains vaporized fuel absorbed by the canister 80 and air introduced through the atmosphere passing hole 84. Thus, the purge fuel amount tau is expressed by Formula (4), and the purge air amount ga is expressed by Formula (5). Then, the normal fuel injection amount TAUn calculated in Step S110, the intake air flow Ga, the purge air amount ga, and the purge fuel amount tau are assigned to Formula (6) to set a fuel injection amount TAU to be injected from the fuel injection valve 73 (Step S190). Specifically, the actual intake air flow per one rotation of the engine is the sum of the intake air flow Ga and the purge air amount ga, thus a fuel injection amount appropriate to the sum is calculated, and a value obtained by subtracting the purge fuel amount tau having existed in the intake pipe 70a from the calculated fuel injection amount is set as the fuel injection amount TAU. After the fuel injection amount TAU is set in Step S190 or Step S200, this routine is finished.

tau=[(g+G)/Ne]·Cf/100 (4)

ga=g/Ne−tau (5)

TAU=[TAUn·(Ga+ga)/Ga]−tau (6)

With the hybrid vehicle 20 of the embodiment described above in detail, in performing the purge control, the purge air amount ga and the purge fuel amount tau are derived on the basis of the intake pipe pressure PM from the intake pipe pressure sensor 112 when the intake pipe pressure sensor 112 is functioning normally, and the purge air amount ga and the purge fuel amount tau are derived on the basis of the load factor L derived from the intake air flow G obtained from the air flow meter 108 when the intake pipe pressure sensor 112 is not functioning normally, though the purge air amount ga and the purge fuel amount tau tend to have slightly larger errors than in the case of using the intake pipe pressure PM from the intake pipe pressure sensor 112 functioning normally. Thus, even when the intake pipe pressure sensor 112 is not functioning normally, a deviation of an air/fuel ratio caused by the purge control can be appropriately eliminated.

In the embodiment, the fuel concentration Cf of the gas in the intake pipe is calculated on the basis of the intake pipe pressure PM from the intake pipe pressure sensor 112 and the output value from the intake oxygen sensor 114. However, the fuel concentration Cf may be calculated without using the output value from the intake oxygen sensor 114. For example, the fuel concentration Cf may be calculated using the air/fuel ratio Vaf from the air/fuel ratio sensor 92 after injection of the normal fuel injection amount TAUn from the fuel injection valve 73. Specifically, the fuel concentration Cf may be calculated so that a value obtained by dividing the sum of the new intake air flow Ga and the purge air amount ga (see Formula (5)) by the sum of the actually injected fuel injection amount TAUn and the purge fuel amount tau (see Formula (4)) is the air/fuel ratio Vaf as in Formula (7). This eliminates the need for mounting the intake oxygen sensor 114 to the intake pipe 70a.

Vaf=(Ga+ga)/(TAUn+tau) (7)

In the embodiment, the maximum intake air flow Gamax is used in Formula (3) when the load factor L of the engine 22 is calculated from the intake air flow G obtained from the air flow meter 108. However, the maximum intake air flow Gamax is changed according to volumetric efficiency of intake air, and the volumetric efficiency of the intake air is changed according to an intake temperature, and thus the maximum intake air flow Gamax in Formula (3) may be corrected on the basis of the intake temperature. Thus, a deviation of an air/fuel ratio caused by the purge control can be more appropriately eliminated when the intake pipe pressure sensor 112 is not functioning normally.

In the embodiment, the internal combustion engine apparatus mounted in the hybrid vehicle 20 that can drive using power from the engine 22 and power from the motor MG2 has been described, but an internal combustion engine apparatus may be mounted in an automobile that drives using power only from the engine without a motor that outputs driving power, or an internal combustion engine apparatus may be mounted in vehicles other than automobiles or mobile bodies such as ships or aircraft, or may be incorporated into immovable facilities such as construction facilities. The technique described in the above embodiment may be also realized as a control method of the internal combustion engine apparatus.

Correspondence between main elements in the embodiment and main elements described in SUMMARY OF THE INVENTION will be described. In the embodiment, the engine 22 corresponds to “internal combustion engine”, the throttle valve 72 corresponds to “air amount adjustment unit”, the intake pipe pressure sensor 112 corresponds to “intake pipe pressure detection unit”, the air flow meter 108 corresponds to “intake air flow detection unit”, the canister 80 corresponds to “vaporized fuel capturing unit”, and the engine ECU 24 that executes the fuel injection control routine in FIG. 3 corresponds to “purge control performing unit”. The “internal combustion engine” is not limited to the internal combustion engine that outputs power using hydrocarbon fuel such as gasoline or gas oil, but may be of any type such as a hydrogen engine. The “air amount adjustment unit” is not limited to the throttle valve 72, but may be of any type that can adjust an amount of air taken into an intake pipe. The “intake pipe pressure detection unit” is not limited to the intake pipe pressure sensor 112 of the silicon diaphragm type, but may be of any type that can detect intake pipe pressure. The “intake air flow detection unit” is not limited to the air flow meter 108 of the hot wire type, but may be of any type that can detect an amount of air taken into an intake pipe such as an air flow meter of a vane type or a Karman vortex type. The “vaporized fuel capturing unit” is not limited to the canister 80, but may be of any type that captures vaporized fuel in a fuel tank that stores fuel to be supplied to the internal combustion engine. The “purge control performing unit” is not limited to the engine ECU 24, but may be constituted by a plurality of electronic control units. The “purge control performing unit” may be of any type that estimates amounts of purge air and purge fuel contained in a purge gas flowing into an intake pipe during performing purge control on the basis of intake pipe pressure detected by an intake pipe pressure detection unit when the intake pipe pressure detection unit is functioning normally, and estimates the amounts of purge air and purge fuel on the basis of the intake air flow detected by an intake air flow detection unit when the intake pipe pressure detection unit is not functioning normally, in performing purge control. The correspondence between the main elements in the embodiment and the main elements in the invention described in SUMMARY OF THE INVENTION do not limit the elements in the invention described in SUMMARY OF THE INVENTION since the embodiment is an example for describing in detail the best mode for carrying out the invention described in SUMMARY OF THE INVENTION. Specifically, the invention described in SUMMARY OF THE INVENTION should be construed on the basis of the description therein, and the embodiment is merely a detailed example of the invention described in SUMMARY OF THE INVENTION.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

The present application claims priority from the Japanese Patent Application No. 2008-130379 filed on May 19, 2008, the entire contents of which are incorporated herein by reference.

What is claimed is:

1. An internal combustion engine apparatus comprising:
an internal combustion engine;
an air amount adjustment unit that is mounted to an intake pipe of said internal combustion engine and adjusts an amount of air taken into said intake pipe;
an intake pipe pressure detection unit that is mounted downstream of said air amount adjustment unit and detects intake pipe pressure;
an intake air flow detection unit that is mounted upstream of said air amount adjustment unit and detects the amount of air taken into said intake pipe;
a vaporized fuel capturing unit that captures vaporized fuel in a fuel tank that stores fuel to be supplied to said internal combustion engine;
a purge passage connecting said vaporized fuel capturing unit and said intake pipe; and
a purge control performing unit that, in performing purge control for introducing vaporized fuel captured by said vaporized fuel capturing unit through said purge passage into said intake pipe using negative pressure in said intake pipe, estimates amounts of purge air and purge fuel contained in a purge gas flowing into said intake pipe during the purge control on the basis of the intake pipe pressure detected by said intake pipe pressure detection unit when said intake pipe pressure detection unit is functioning normally, and estimates the amounts of purge air and purge fuel on the basis of the intake air flow detected by said intake air flow detection unit when said intake pipe pressure detection unit is not functioning normally.

2. An internal combustion engine apparatus according to claim 1, wherein said purge control performing unit determines that said intake pipe pressure detection unit is not functioning normally when said intake pipe pressure detection unit is disconnected or short-circuited.

3. An internal combustion engine apparatus according to claim 1, wherein said purge control performing unit determines that said intake pipe pressure detection unit is not functioning normally when the intake pipe pressure detected by said intake pipe pressure detection unit during operation of said internal combustion engine exceeds reference atmospheric pressure.

4. An internal combustion engine apparatus according to claim 1, wherein said purge control performing unit determines that said intake pipe pressure detection unit is not functioning normally when the intake pipe pressure detected by said intake pipe pressure detection unit is fixed at a constant value irrespective of an operation state of said internal combustion engine.

5. An internal combustion engine apparatus according to claim 1, wherein said purge control performing unit determines that said intake pipe pressure detection unit is not functioning normally when an ambient temperature of said intake pipe pressure detection unit is within a predetermined low temperature range.

6. A vehicle comprising an internal combustion engine apparatus according to claim 1, and driving using power from said internal combustion engine.

7. A control method that is executed by a computer software and is applied to an internal combustion engine apparatus including: an internal combustion engine; an air amount adjustment unit that is mounted to an intake pipe of said internal combustion engine and adjusts an amount of air taken into said intake pipe; an intake pipe pressure detection unit that is mounted downstream of said air amount adjustment unit and detects intake pipe pressure; an intake air flow detection unit that is mounted upstream of said air amount adjustment unit and detects the amount of air taken into said intake pipe; a vaporized fuel capturing unit that captures vaporized fuel in a fuel tank that stores fuel to be supplied to said internal combustion engine; and a purge passage connecting said vaporized fuel capturing unit and said intake pipe, said control method comprising:
in performing purge control for introducing vaporized fuel captured by said vaporized fuel capturing unit through said purge passage into said intake pipe using negative pressure in said intake pipe, estimating amounts of purge air and purge fuel contained in a purge gas flowing into said intake pipe during the purge control on the basis of the intake pipe pressure detected by said intake pipe pressure detection unit when said intake pipe pressure detection unit is functioning normally, and estimating the amounts of purge air and purge fuel on the basis of the intake air flow detected by said intake air flow detection unit when said intake pipe pressure detection unit is not functioning normally.
